(19) United States
(12) Patent Application Publication
(10) Pub. No.: US 2005/0028627 A1
(43) Pub. Date: Feb. 10, 2005

(54) Gear reduction unit

(76) Inventor: Yakov Fleytman, Lake Orion, MI (US)

Correspondence Address: YAKOV FLEYTMAN, 3233 HICKORY DRIVE, LAKE ORION, MI, 48359, US

(21) Appl. No.: 10/655,261

(22) Filed: Sep. 4, 2003

Related U.S. Application Data
(63) Continuation-in-part of application No. 10/633,763, filed on Aug. 4, 2003.

(51) Int. Cl. F16H 1/12

(52) U.S. Cl. 74/416

(57) ABSTRACT

A gear reduction unit is provided with a unique combination of right angle gears with means for distinct connection of pinions or gears with an independent shaft. The gear reduction unit has many variations with different types of right angle gears, according with the desired numbers of ratios and torque and size requirements. The gear reduction unit is more efficient, quite and more compact than conventional parallel shaft or planetary systems which have been typically used in power regulating transmissions. The gear reduction unit of the present invention is easily manufactured.

This is a continuation in part of patent application Ser. No. 10/633,763 filed on Aug. 4, 2003.

### FIELD OF THE INVENTION

The present invention relates to a gear apparatus, particularly to multi speed gear transmissions for mechanical energy regulation. They are used to reduce or to increase speed or increase or reduce torque in helicopter or automobile gearboxes, turbine gearboxes, ship's transmission, and industrial applications. Certain applications may be outside of these fields, like power windows, doors or seats, power steering systems, chainless bicycle or motorcycle transmissions, and much more.

### BACKGROUND OF THE INVENTION

A right angle gear transmission is well known for the transformation of motion and power between shafts where the axis of the pinion and the gear may be crossed or intersected.

Common multi speed gearboxes include primary and secondary gear assemblies, each having a driving member and a driven follower member. In low ratio gearboxes, gear assembly usually uses spur gears or helical gears and for highest ratios or for more variations of ratio, gearboxes have an additional countershaft with additional gear assemble. Another choice for multi speed gearboxes involves using planetary gear sets consisting mostly of the following elements: ring gear, sun gear and planetary carrier cage. To have multi speed right angle transmission a combination of right angle gear set and multi speed transmission with parallel shafts is used. It makes multi speed right angle gearbox complicated and larger, while reducing efficiency and producing more noise.

Right angle gears are known to be used where these gears are coaxially arranged and connected to each other to transfer power with unchangeable ratio. In the Saari patent (U.S. Pat. No. 2,908,187) relatively large face-type worm gears and second and relatively smaller similar face-type worm gears are coaxially fixed to the output. First worm is in mesh with large worm gear, second worm is in mesh with smaller worm gear and both worms are fixed to an input shaft.

In multiplex bevel gearing by Kirsten (U.S. Pat. No. 2,418,555), two members rotating about axes consisting of plurality of pinions permanently connected to one shaft are in mesh with plurality of position adjustable bevel gears. Both members are also connected to each other. In the patent, bevel gears transmit power simultaneously. According with Gleason (U.S. Pat. No. 1,848,342), a tapered gear comprising of a rotational unit of outer and inner members in mesh with another rotating unit of pinions connected to one shaft.

### SUMMARY OF THE INVENTION

Right angle gears have a very wide use in many applications. Right angle gears for the same size of the pinion and the same ratio have almost twice the torque capacity of traditional parallel shaft gearings. This is primarily due to high contact ratio. When it is necessary to change gear ratio a combination of right angle gears attached to variable or changeable ratio gears with parallel shafts is usually used. Present invention makes right angle multi speed gear boxes more simple and efficient, with a more compact design. It allows multi speed right angle gear box to be used in completely new applications, like variable ratio drive axle attached to front or rear axle, chainless transfer case, in bicycle or motorcycle transmissions and more.

Further areas of applicability of the present invention will become apparent from the detailed description provided hereinafter. It should be understood however that the complete description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the comprehensive description and the accompanying drawings, wherein:

FIG. 1 is an isometric view of coaxially mounded two spiral bevel gears in mesh with coaxially mounded two pinions.

FIG. 2 is an isometric view of coaxially mounded two spiral bevel gears in mesh with two coaxial pinions with gear teeth faces facing in one direction and two spiral bevel gears in mesh with two coaxial pinions with gear teeth faces facing in opposite directions.

FIG. 3 is an isometric view of coaxially mounded face gears of enveloping worm face gear in mesh with two coaxial enveloping worms having threads with less than 90 degrees of revolution with gear teeth faces facing in one direction and two coaxially mounded face gears of enveloping worm face gears in mesh with two enveloping worms having threads with less than 90 degrees of revolution with gear teeth faces facing in opposite directions and pinions opposing each other.

FIG. 4 is an isometric view of FIG. 2 with two additional coaxially mounded spiral bevel gears placed to the bottom of spiral bevel gears of FIG. 2.

FIG. 5 is an isometric view of coaxially mounded face gears of enveloping worm face gear in mesh with two coaxial enveloping worms having threads with less than 90 degrees of revolution with gear teeth faces facing in one direction and two coaxially mounded face gears of enveloping worm face gears in mesh with two enveloping worms having threads with less than 90 degrees of revolution with gear teeth faces facing in opposite directions.

FIG. 6 is an isometric view of two coaxially mounded gears of spiral bevel gears in mesh with spiral bevel gear pinions with gear teeth faces facing in one direction and two coaxially mounded gears of spiral bevel gears in mesh with spiral bevel gear pinions with gear teeth faces facing in opposite directions and pinions opposing each other.

FIG. 7 is an isometric view of FIG. 3 with two additional coaxially mounded face gears of enveloping face gears placed to the bottom of enveloping face gears of FIG. 3.

FIG. 8 is an isometric view of a gear reduction unit with six sets of face gears.

FIG. 9 is an isometric view of a face gear of enveloping worm face gear in mesh with enveloping worm having threads with less than 90 degrees of revolution and parallel shaft gear spur or helical type attached to the face gear.

FIG. 10 is an isometric view of coaxially mounded two face gears of enveloping worm face gear in mesh with two coaxial enveloping worms having threads with less than 90 degrees of revolution and parallel shaft gear, spur or helical type, attached to the face gear.

FIG. 11 is an isometric view of two coaxially mounded face gears of enveloping worm face gears in mesh with two coaxial enveloping worms having threads with less than 90 degrees of revolution with gear teeth faces facing in one direction and coaxially mounded face gear of enveloping worm face gears in mesh with enveloping worm having threads with less than 90 degrees of revolution with gear teeth faces facing in opposite directions and parallel shaft gear, spur or helical type, attached between the face gears.

FIG. 12 is an isometric view of two coaxially mounded face gears of enveloping worm face gears in mesh with two coaxial enveloping worms having threads with less than 90 degrees of revolution with gear teeth faces facing in one direction and coaxially mounded two face gear of enveloping worm face gears in mesh with two enveloping worm having threads with less than 90 degrees of revolution with gear teeth faces facing in opposite directions and parallel shaft gear, spur or helical type, attached between the face gears.

FIG. 13 is an isometric view of four sets of face gears, where the first set consists of first and second coaxially mounded face gears of enveloping worm face gears in mesh with first and second coaxial enveloping worms having threads with less than 90 degrees of revolution with gear teeth faces facing in one direction and the second set consists of first and second coaxially mounded face gears of enveloping worm face gears in mesh with first and second coaxial enveloping worms having threads with less than 90 degrees of revolution with gear teeth faces facing in opposite direction. First and second face gears are attached to first parallel shaft gear spur or helical type. Third set of gears consists of first and second coaxially mounded face gears of enveloping worm face gears in mesh with first and second coaxial enveloping worms having threads with less than 90 degrees of revolution with gear teeth faces facing in one direction. Fourth set consist of first and second coaxially mounded face gears of enveloping worm face gears in mesh with first and second coaxial enveloping worms having threads with less than 90 degrees of revolution with gear teeth faces facing in opposite direction. First and second face gears are attached to second parallel shaft gear spur or helical type. First and second parallel shaft gear spur or helical type are in kinematical connection.

FIGS. 14, 15 and 16 are isometric views of four sets of face gears, where the first set consists of first and second coaxially mounded face gears of enveloping worm face gears in mesh with first and second coaxial enveloping worms having threads with less than 90 degrees of revolution with gear teeth faces facing in one direction and the second set consist of first and second coaxially mounded face gears of enveloping worm face gears in mesh with first and second coaxial enveloping worms having threads with less than 90 degrees of revolution with gear teeth faces facing in opposite direction. Face gears are in connection with first parallel shaft gear spur or helical type. Third set of gears consists of first and second coaxially mounded face gears of enveloping worm face gears in mesh with first and second coaxial enveloping worms having threads with less than 90 degrees of revolution with gear teeth faces facing in one direction. Fourth set consists of first and second coaxially mounded face gears of enveloping worm face gears in mesh with first and second coaxial enveloping worms having threads with less than 90 degrees of revolution with gear teeth faces facing in opposite direction. First and second face gears are attached to second parallel shaft gear spur or helical type. First and second parallel shaft gear spur or helical type is in direct kinematical connection.

FIG. 17 is an isometric view of coaxially mounded face gear of enveloping worm face gear in mesh with enveloping worm having threads with less than 90 degrees of revolution and parallel shaft gear spur or helical type attached to only one face gear.

FIG. 18 is a schematic view of a gear reduction unit with one set of face or bevel type gears with gear teeth face facing in one direction and two sets of face or bevel type gears with gear teeth faces facing in opposite direction where output shaft is able to connect to an input shaft.

FIG. 19 is a schematic view of a gear reduction unit with two sets of face or bevel type gears and an additional pinion.

FIG. 20 is a schematic view of a gear reduction unit with two sets of face or bevel type gears distinctly connecting first pinion and second pinion to the input shaft and the second pinion is also attached to an output shaft.

FIG. 21 is schematic view of a gear reduction unit from FIG. 20 used in a transfer case of automotive power train.

FIG. 22 is a schematic view of a gear reduction unit with four sets of face or bevel type gears.

FIG. 23 is a schematic view of a gear reduction unit with six sets of face or bevel type gears.

FIG. 24 is a schematic view of a gear reduction unit with two sets of face or bevel type gears in a kinematical connection with other two sets of face or bevel type gears, where pinion could be used for output motion.

FIG. 25 is a schematic view of a gear reduction unit with two sets of face or bevel type gears in a kinematical connection with other two sets of face or bevel type gears, where pinions are used for input/output and gears provide input/output motion.

FIG. 26 is a schematic view of a gear reduction unit with two sets of face or bevel type gears in a kinematical connection with other two sets of face or bevel type gears, where pinions could be used for input/output motion. This schematic view has additional two sets of face or bevel type gears, with pinions attached to face gears of first and second gear sets.

FIG. 27 is a schematic view of a gear reduction unit with two sets of face or bevel type gears in a kinematical connection with other two sets of face or bevel type gears, where second gears of first and second pair of gears are in kinematical connection with second gears of third and fourth pair of gears.

FIG. 28 is a schematic view of gear a reduction unit with two sets of face or bevel type gears in a kinematical connection with other two sets of face or bevel type gears, where second gear of first pair of gears is in kinematical connection with second gear of third pair of gears and second gear of second pair of gears is in kinematical connection with second gear of fourth pair of gears.

### DETAILED DESCRIPTION OF THE PREFERRED EMBODIMENTS

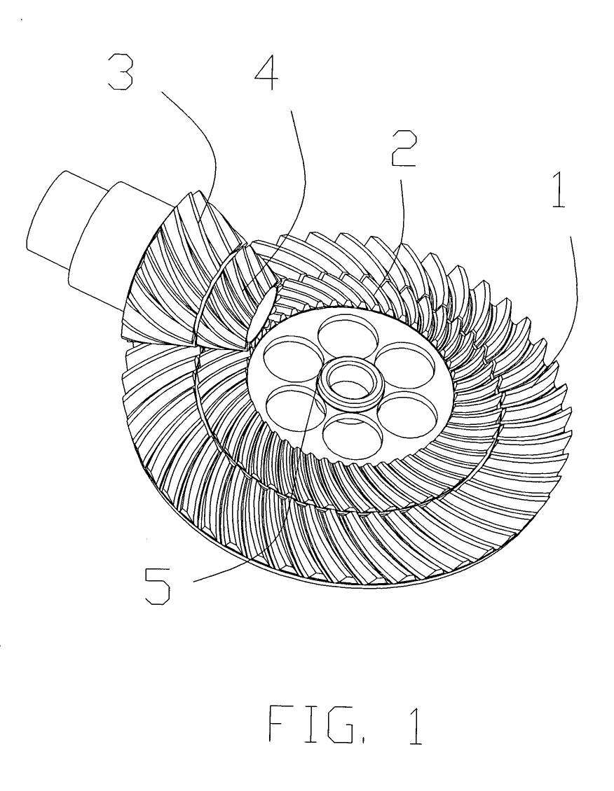

The following discussion relating to FIGS. 1-28 provides a detailed description of the unique gear reduction unit which can be utilized with the present invention. More torque capacity is the main advantage for using the right angle gears. For various torque capacities and design requirements different right angle gear sets could be used. Spiral bevel gears and hypoid gears are bevel type right angle gears. In pair of gears a pinion is a gear with less or equal number of gear teeth. Gears shown in schematic view could be bevel type (spiral bevel or hypoid) or face gear with regular worm or enveloping worm having threads with less than 90 degrees of revolution.

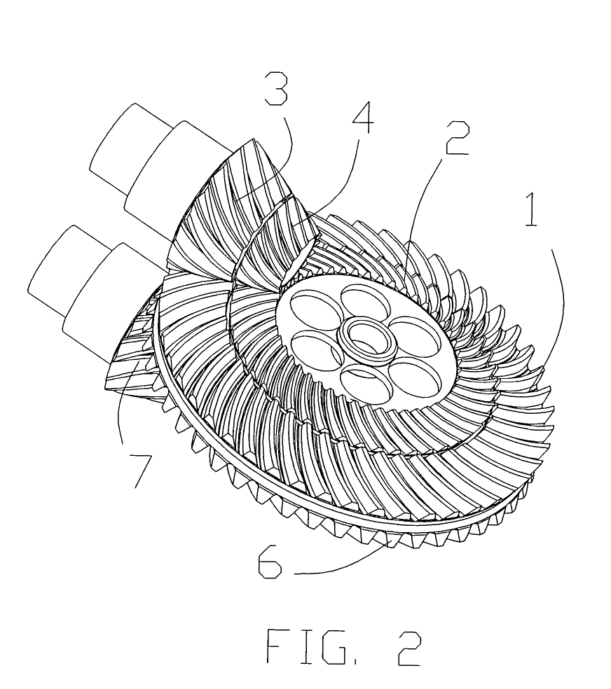

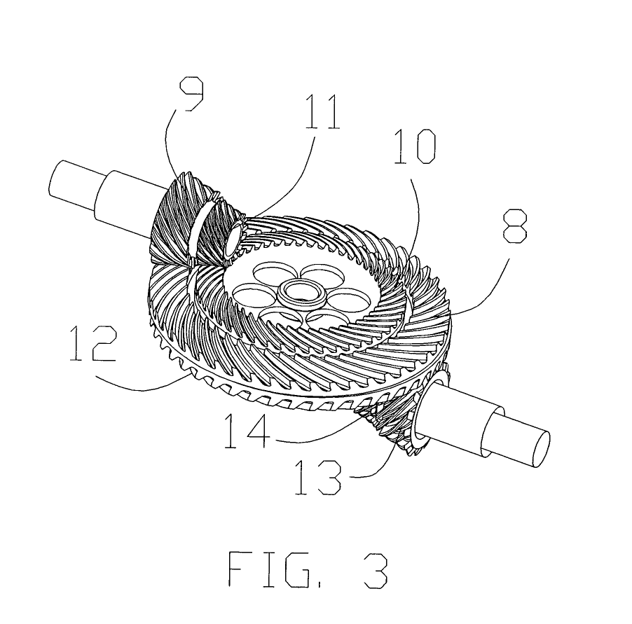

FIG. 1 is an isometric view of coaxially mounded first spiral bevel 1 and second spiral bevel gears 2 gears in mesh with coaxially mounded first pinion 3 and second pinion 4. Gears 1 and 2 are connected to each other. Output member 5 of gears 1 and 2 may be linked to a source of mechanical energy or to a load. Pinions 3 and 4 are coaxially arranged in order to rotate independently to each other. Gears shown in FIG. 1 may be replaced with any face gears, like gears where the pinion is a regular worm or enveloping worm with threads with less than one revolution. FIG. 2 is an isometric view of coaxially mounded and connected to each other spiral bevel gears 1 and 2 in mesh with two coaxial pinions 3 and 4 having gear teeth faces facing in one direction and spiral bevel gears 6 and another gear not shown in this view are in mesh with coaxial pinion 7 and with another pinion not shown in this view having gear teeth faces facing in opposite direction. This configuration of gears makes a very compact design of right angle reduction gears for using in 4 speed gear box. Four face gears 1, 2 and 6 and not shown on the FIG. 2 can be made at once. The most productive way is near-net technology. FIG. 3 is an isometric view face gears 8 of enveloping worm face gear in mesh with enveloping worm 9 and enveloping worm face gear 10 coaxially mounded and connected to gear 8 in mesh with enveloping worm 11. Two coaxial enveloping worms 9 and 11 have threads with less than one revolution. The enveloping worm face transmission is a new type of right angle gears (U.S. patent application No. 10/435,143) and basic set comprises a worm gear (face gear 8) and an enveloping worm 9. Said enveloping worm 9 having at least one thread that is engaged by at least one tooth of said worm gear 8 wherein said worm gear is a face gear and said enveloping worm 9 is placed into face arrangement with said worm gear 8. In this enveloping worm face transmission the enveloping worm 9 could have any design, however, it is preferred that the enveloping worm is utilized for standard enveloping or double enveloping worm/worm gear transmission. Pinions 9 and 11 are coaxially arranged to rotate independently to each other. Additional face gears 12 and not shown on picture in mesh with two coaxial worms 13 and 14 having threads with less than one revolution. Pinions 9, 11 and pinions 13, 14 oppose each other.

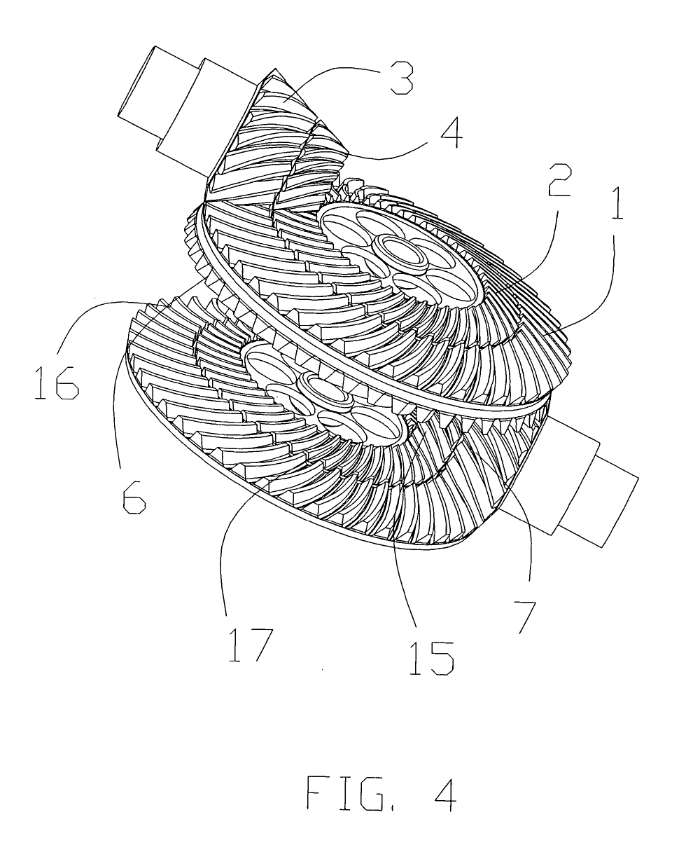

FIG. 4 is an isometric view of coaxially mounded and connected to each other spiral bevel gears 1 and 2 in mesh with two coaxial pinions 3, 4 and coaxially mounded and connected to each other spiral bevel gear 6 and not shown another spiral bevel gear in mesh with two coaxial pinions 7 and 15. First spiral bevel gear 1 and second spiral bevel gear 2 have teeth faces facing in opposite directions to third spiral bevel gear 6 and not shown spiral bevel gear. On the bottom of FIG. 4 are additional spiral bevel gears 16 and 17 in mesh with pinions 7 and 15.

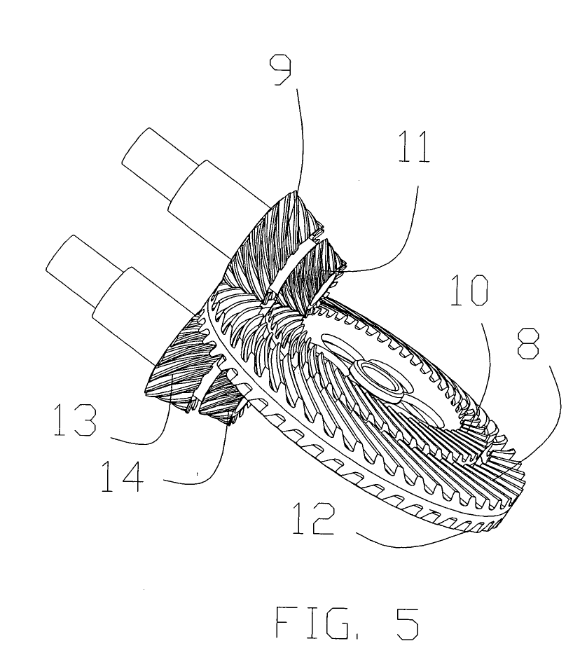

FIG. 5 shows the same relations between right angle gears and pinions like FIG. 3 where two coaxially mounded and connected to each other face gears 8 and 10 of enveloping worm face gears are in mesh with two coaxial enveloping worms 9 and 11 having threads with less than one revolution. Two coaxially mounded and connected to each other face gears 12 and not shown gear of enveloping worm face gears in mesh with two enveloping worms 13 and 14 having threads with less than one revolution. Teeth faces of gears 8 and 10 are facing in opposite directions to gears 12 and not shown gear teeth faces.

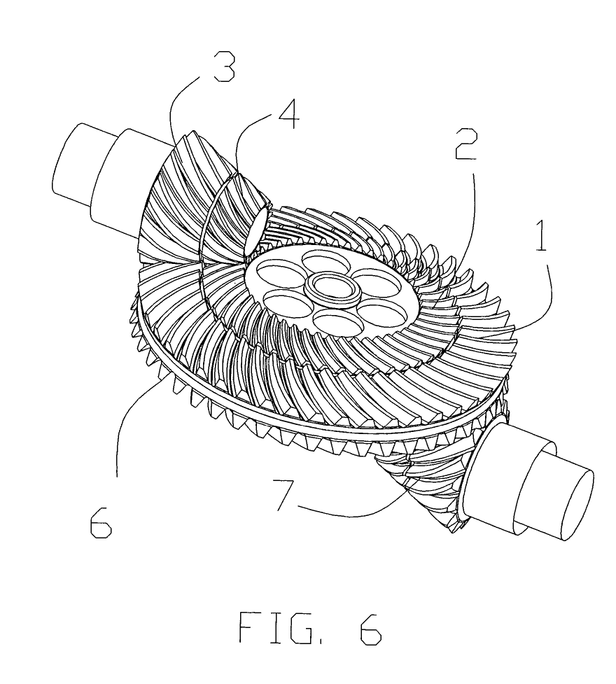

FIG. 6 is the same as FIG. 2, but the only difference is that pinions are opposing each other. Advantage of such layout is that all pinions rotate in the same direction and are more accessible for independent input or output. By changing location of mesh between the gear and the pinion we can change direction of rotation of pinion or the gear.

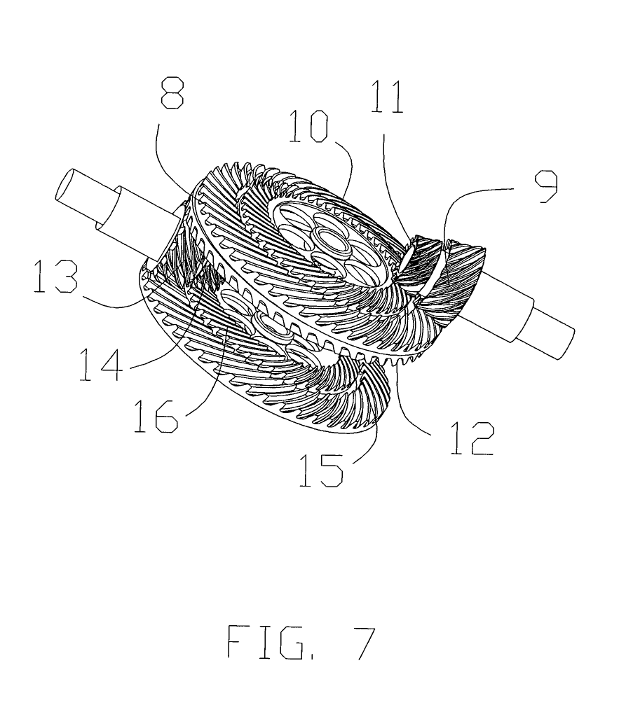

FIG. 7 compared to FIG. 5 has additional enveloping face gears 15 and 16 in mesh with pinions 13 and 14 on the bottom.

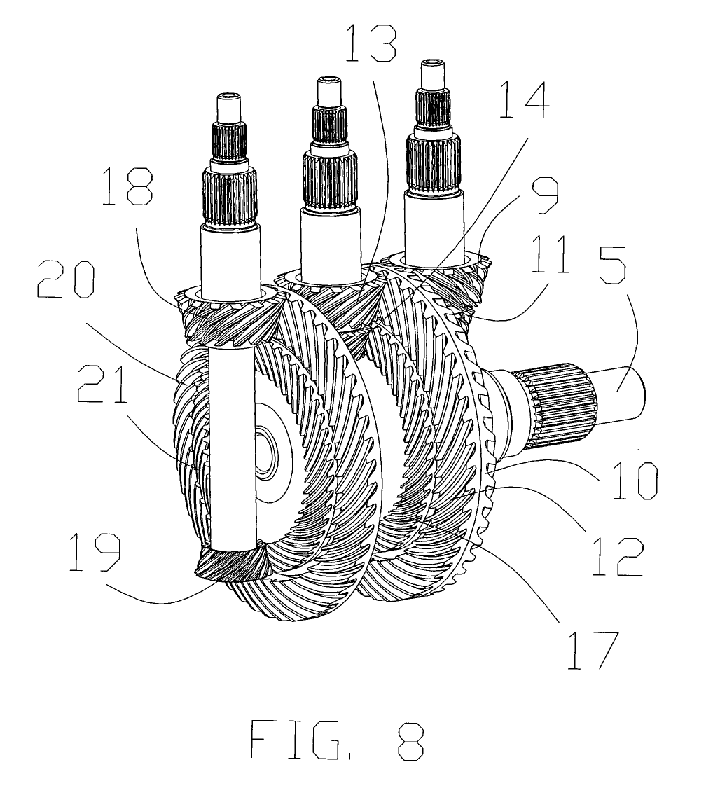

FIG. 8 is an isometric view of a gear reduction unit with six sets gears where in addition to FIG. 5 it has not shown before gear 17 and additional set of gears where pinions 18 and 19 are in mesh with gears 20 and 21.

Gear reduction unit works like any gear reduction unit with constant gear mesh. By means according with desired ratio it connects the chosen pinion to a shaft linking to source of energy or load. Gear reduction unit transfers power from any pinion to shaft 5 or from shaft 5 to any pinion or from any pinion to another pinion with different combinations of needed ratios.

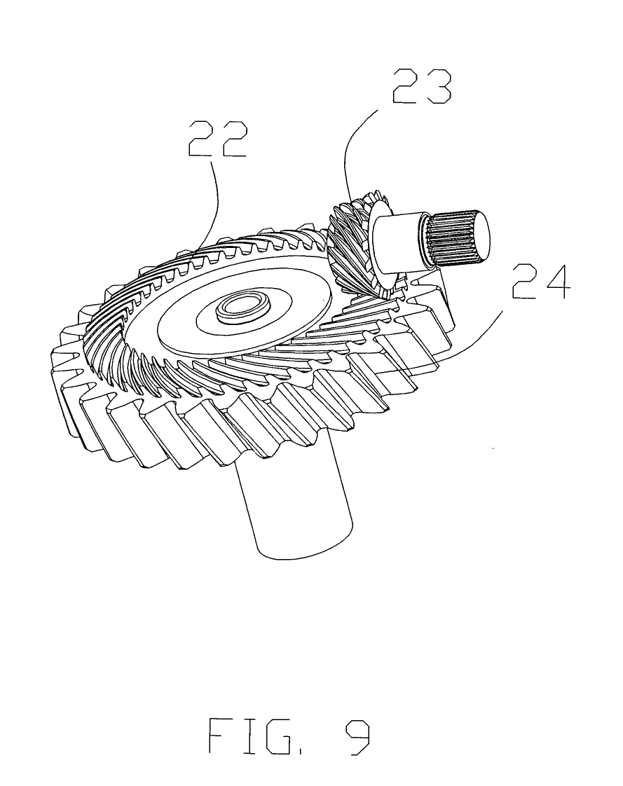

FIG. 9 is an isometric view of coaxially mounded first face gear 22 of enveloping worm face gear in mesh with enveloping worm 23 having threads with less than one revolution and parallel shaft gear 24 spur or helical type attached to the first face gear 22.

FIG. 10 is an isometric view of two coaxially mounded first and second face gears 22 and 25 of enveloping worm face gear in mesh with two enveloping worms 23 and 26 having threads with less than one revolution and parallel shaft gear 24 spur or helical type attached to face gear 22 and 25.

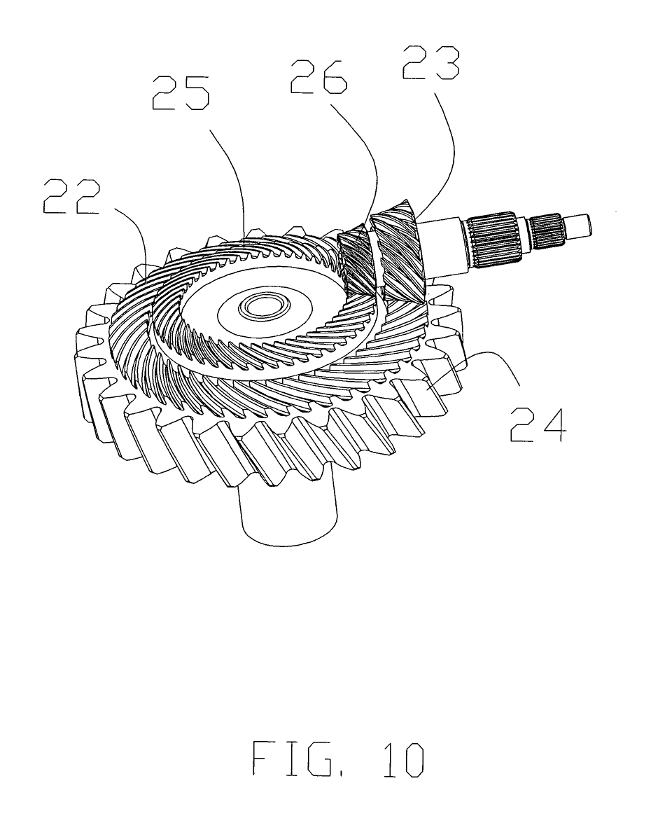

FIG. 11 in addition to FIG. 10 has third face gear 27 of enveloping worm face gear in mesh with enveloping worm 28 having threads with less than one revolution. Parallel shaft gear 24 spur or helical type is attached between face gears 22, 25 and face gear 27. Teeth face of first gear 22 is facing in opposite directions to teeth face of third gear 27 (or second gear if we have only two gears from right angle pair of gears).

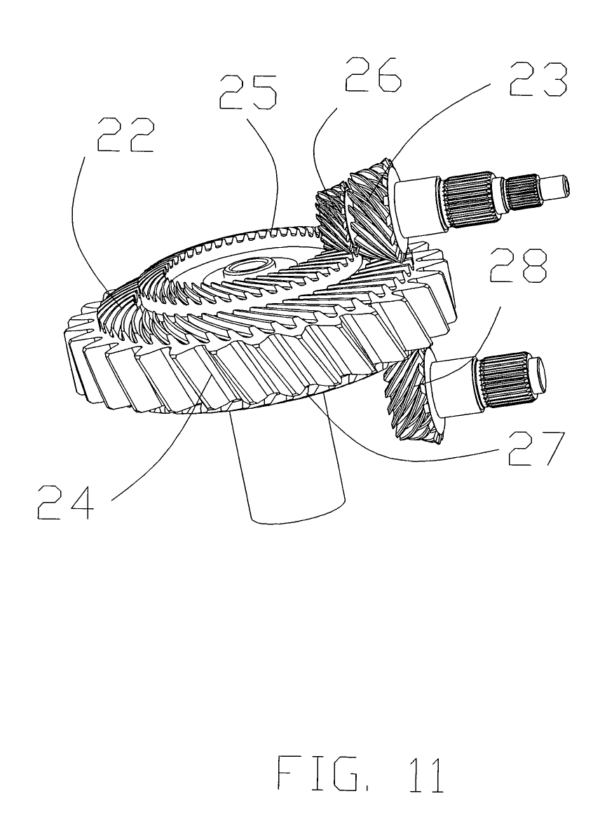

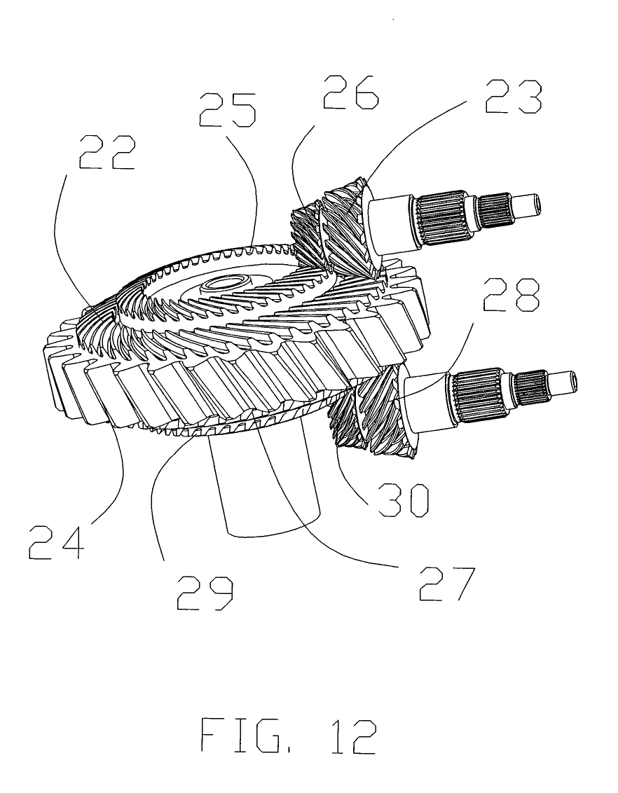

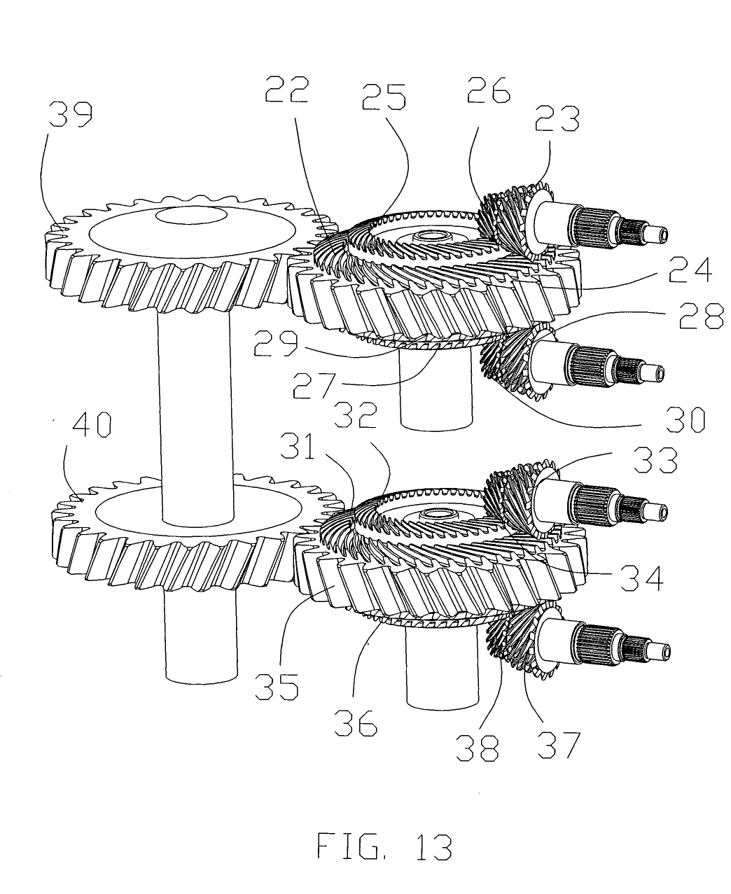

FIG. 12 in addition to FIG. 10 has third and fourth face gears 27 and 29 of enveloping worm face gear in mesh with enveloping worms 28 and 30 having threads with less than one revolution. Parallel shaft gear 24 spur or helical type is attached between face gears 22, 25 and face gear 27, 29. Advantage of using five gears 22, 24, 25 and 27, 29 is that it can be made from one blank of material. The most efficient way is near-net technology, where all five gears can be made at once. FIG. 13 is an isometric view of first and second coaxially mounded face gears 22 and 25 of enveloping worm face gears in mesh with first and second coaxial enveloping worms 23 and 26 having threads with less than one revolution with gear teeth faces facing in one direction in connection with first parallel shaft gear 24 spur or helical type.

Two coaxially mounded third face gear 27 and fourth face gear 29 of enveloping worm face gears in mesh with two enveloping worms, third 28 and fourth 30 having threads with less than one revolution with gear teeth faces in opposite directions are also connected with first parallel shaft gear 24 spur or helical type.

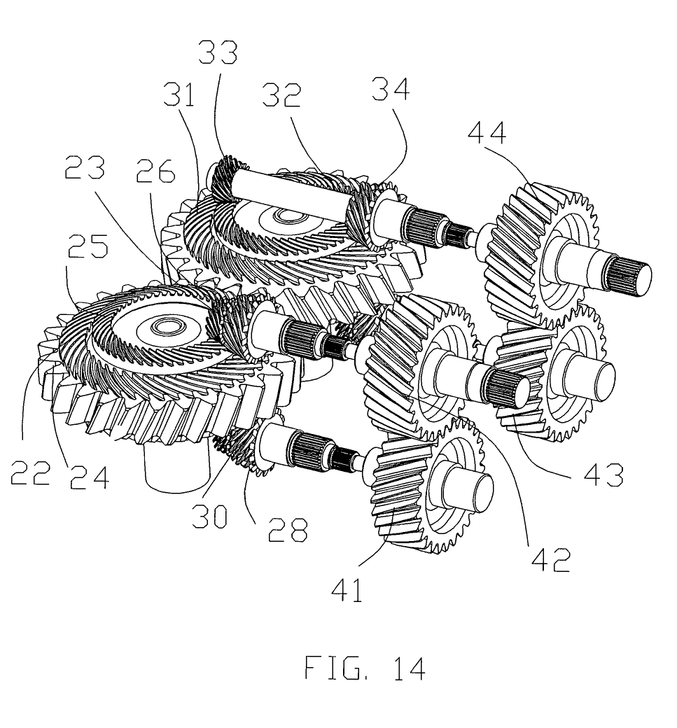

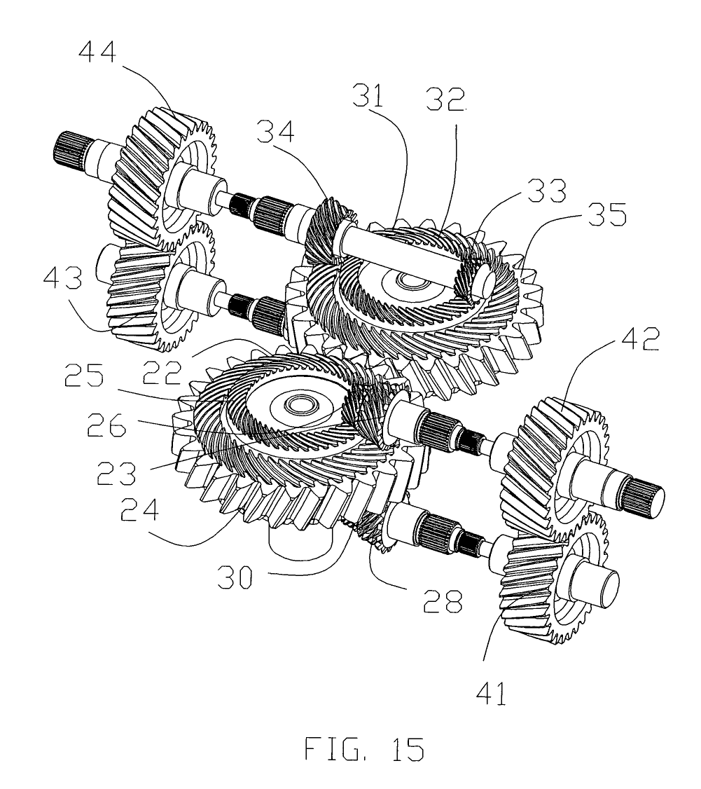

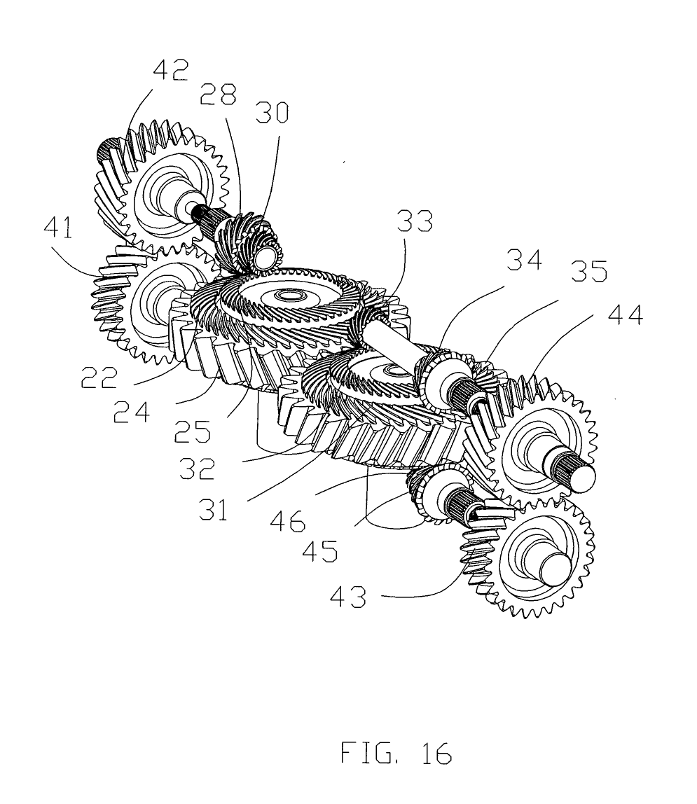

Another four sets of gear have first and second coaxially mounded face gears 31 and 32 of enveloping worm face gears in mesh with first and second coaxial enveloping worms 33 and 34 having threads with less than one revolution with gear teeth faces facing in one direction in connection with second parallel shaft gear 35 spur or helical type. Two additional coaxially mounded face gears 36 and not shown of enveloping worm face gears in mesh with two enveloping worms 37 and 38 having threads with less than one revolution with gear teeth faces in opposite directions are also connected with second parallel shaft gear 35 spur or helical type. Gears 39 and 40 are used for kinematical connection with first and second parallel shafts gear 24 and 35 spur or helical type gears. FIG. 13 shows a total of 8 sets of face or bevel type of gears attached to two parallel shaft gears in kinematical connection by additional spur gears. It could be different numbers of face or bevel type gears connected by additional gears. FIG. 14, FIG. 15 and FIG. 16 have direct connections between face or bevel type gears. Additional spur gears 41, 42, 43 and 44 are used for kinematical connection with pinions 23, 26, 28, 30, 33 and 34, and 45, 46.

Parallel shaft gear 24 spur or helical type could be connected only to one face or bevel type gear 22, where face or bevel type gears 25 will independently rotate, as shown on FIG. 17.

For schematic illustration we are using a pair of enveloping worm face gears; however they could be any face gears, spiral bevel, hypoid gears or any combination of gears described above in FIG. 1-FIG. 17. In a different design any output shaft could be used as an input for mechanical energy or any output shaft could be connected to a load.

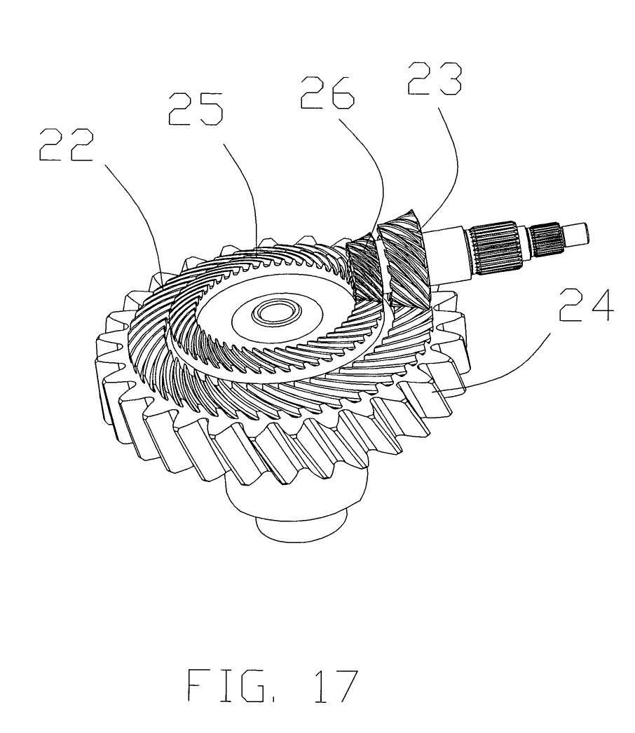

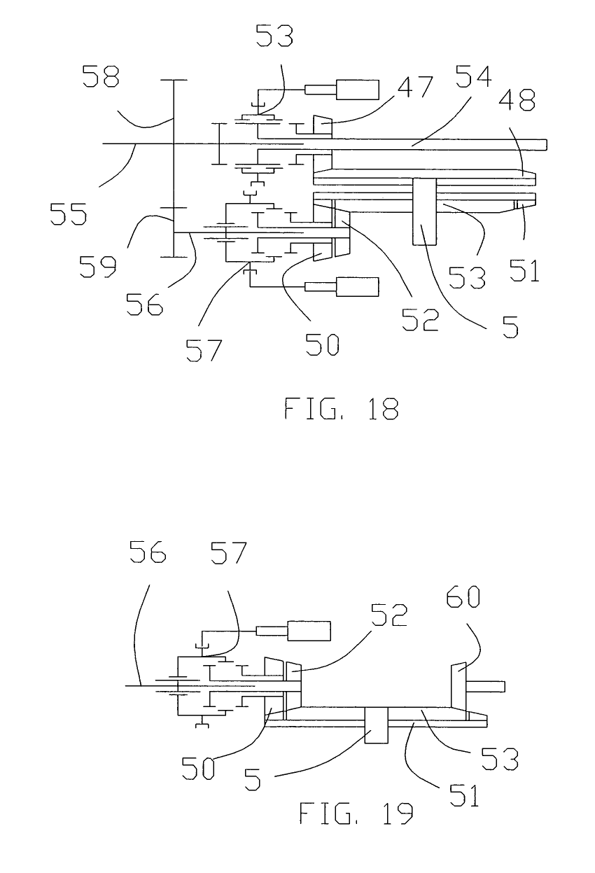

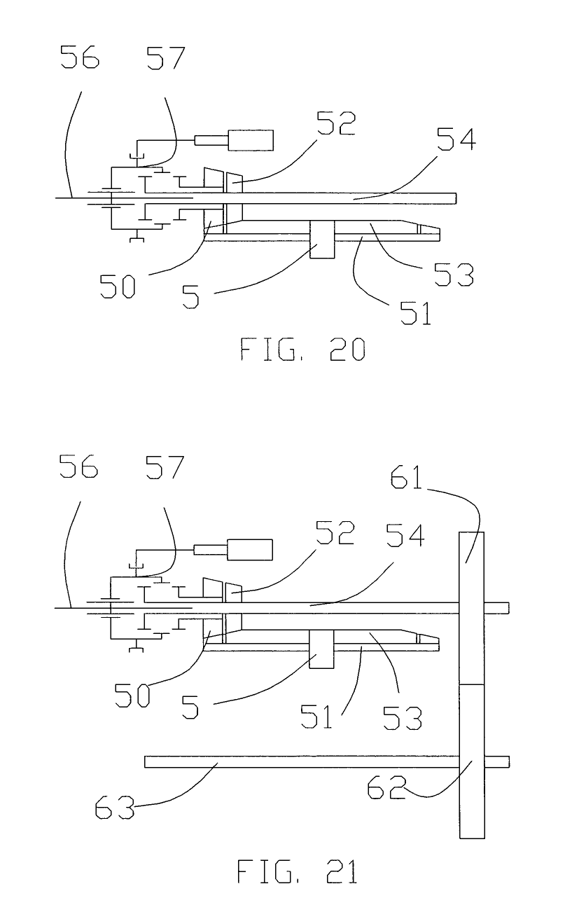

FIG. 18 shows first 47 and second 48 gears of first set face or bevel type gear and first 50 and second 51 gears of second set of face or bevel type gears and first 52 and second 53 gears of third set of face or bevel type gears. Face of gear 48 is facing in opposite direction of faces of gears 51 and 53. The distinct connection of first gear 47 or output shaft 54 to input shaft 55 is done by using means 53. The distinct connection of first gear 50 or first gear 52 to input shaft 56 is done by using means 57. Input shafts 55 and 56 are in kinematical connection by gears 58 and 59. Gears 48, 51 and 53 are connected to shaft 5. Means 53 or means 57 typically includes shift mechanism with sliding dog clutch or electromagnetic clutch or synchromesh shift mechanism. These mechanisms are widely used in automotive power train applications, like transmissions or transfers cases for distinct connection of gears with shafts or to each other. In automotive application input shaft 55 is connected to a source of energy, like engine and output shaft 54 is connected to wheels directly or by a drive axle. Connection of output shaft 54 to input shaft 55 makes direct drive. Combination of connections of first gears 47, 50 and 52 of three sets of gears to input shafts 55, 56 make two additional different ratios on output shaft 54. In FIG. 19 additional gear 60 is in mesh with gear 53 and provides one reverse output with two different ratios. In FIG. 20 output shaft 54 is connected to gear 52.

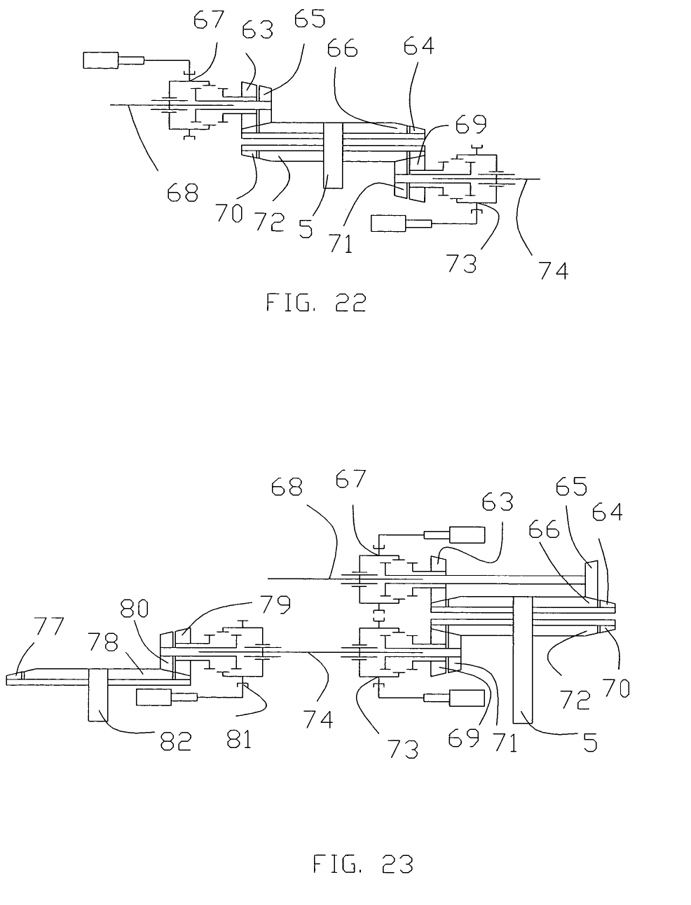

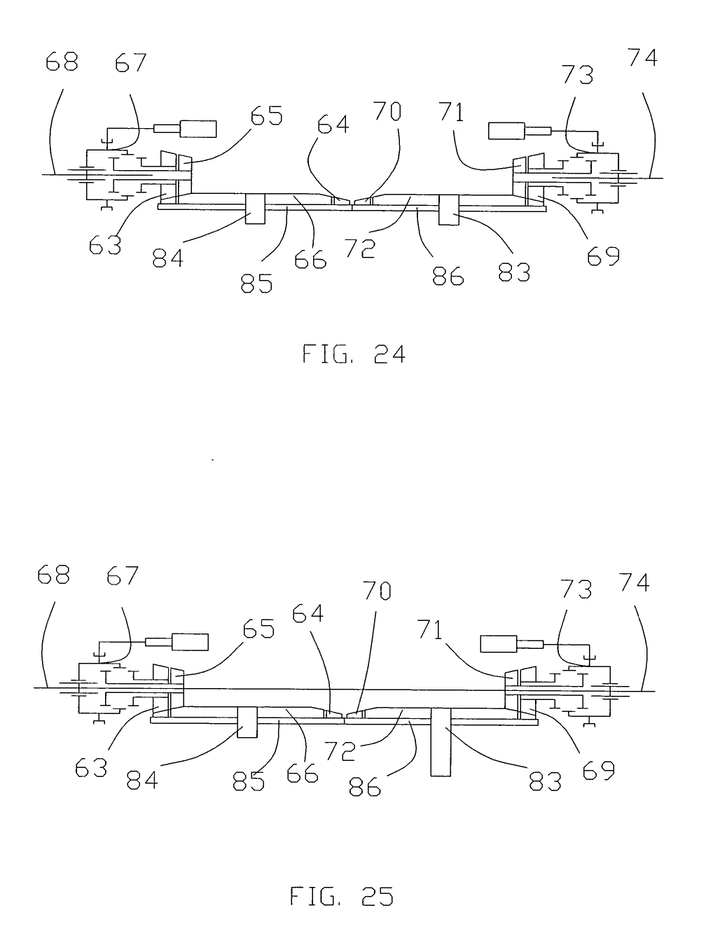

FIG. 21 is an example of using schematic from FIG. 20 in automotive transfer case. Output from vehicles transmission (not shown) is connected to shaft 56. Shaft 54 is connected to rear drive axle (not shown) by gears 61 and 62 to front drive axle (not shown). Gears 61 and 62 can be replaced in to chain drive. When means 57 connects shaft 56 with shaft 52 we have all wheel drive with direct drive by shaft 54. When means 57 connects shaft 56 with gear 50 we have connections with rear and front drive axle with additional ratio. This ratio could be calculated by dividing the ratio between gears 50 and 51 by ratio between gears 53 and 52. FIG. 22 is a schematic view of a gear reduction unit with four sets of face or bevel type gears. It has first gear 63 in mesh with second gear 64 of first set of gears and first gear 65 in mesh with second gear 66 of second set of gears. Means 67 distinctly connects gears 63 and 65 to shaft 68. First gear 69 is in mesh with second gear 70 of third set of gears and first gear 71 is in mesh with second gear 72 of fourth set of gears. Means 73 distinctly connects gears 69 and 71 to shaft 74. In FIG. 23 first gear 65 of second set of gears is placed in opposite location compared to FIG. 22. Shaft 68 or shaft 74 can be input shafts and shaft 5 will be output shaft or vice versa shaft 5 can be input shaft and shaft 68 or shaft 74 will be output shafts. Shaft 68 can be input shaft and shaft 74 will be output shaft. Means 67 and 73 for distinct connection of first gears of four sets of gears to input/output shafts 68, 74 and 5, can be any device that is usually used in constant mesh gearboxes. This device typically includes shift mechanism with sliding dog clutch or electromagnetic clutch or synchromesh shift mechanism. The ratio between gear 63 and gear 64 or the ratio between gear 65 and gear 66 may be chosen to provide output member with the same speed as shaft 68's speed or even higher speed. In vehicle's transmission it provides direct drive or overdrive motion speed. Gears 64, 66 and gears 70 and 72 are attached to shaft 5. Additional set of gears including gears 77 and 78 connected to shaft 5 is in mesh with gears 79 and 80. Mean 81 distinctly connects gears 79 and 80 to shaft 74. Shafts 5, 68 and 82 can be used for input/output mechanical energy. This design could be used for four forward speed and four reverse speed gear box.

In FIG. 24 gears 64 and 66 are attached to parallel shaft gear 85 spur or helical type and connected to shaft 84. Gears 70 and 72 are attached to parallel shaft gear 86 spur or helical type and connected to shaft 83. Using gears 85 and 86 in mesh provides transfer power between shafts 68, 74 and simplifies design of gear reduction unit. Input/output shafts can be any shafts 68, 74 and 83, 84. In FIG. 25 shafts 68 and 74 are connected to each other.

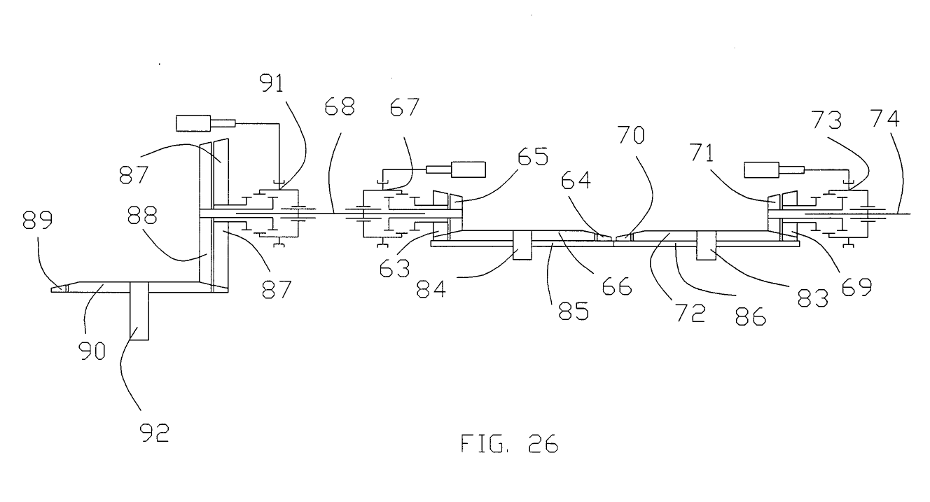

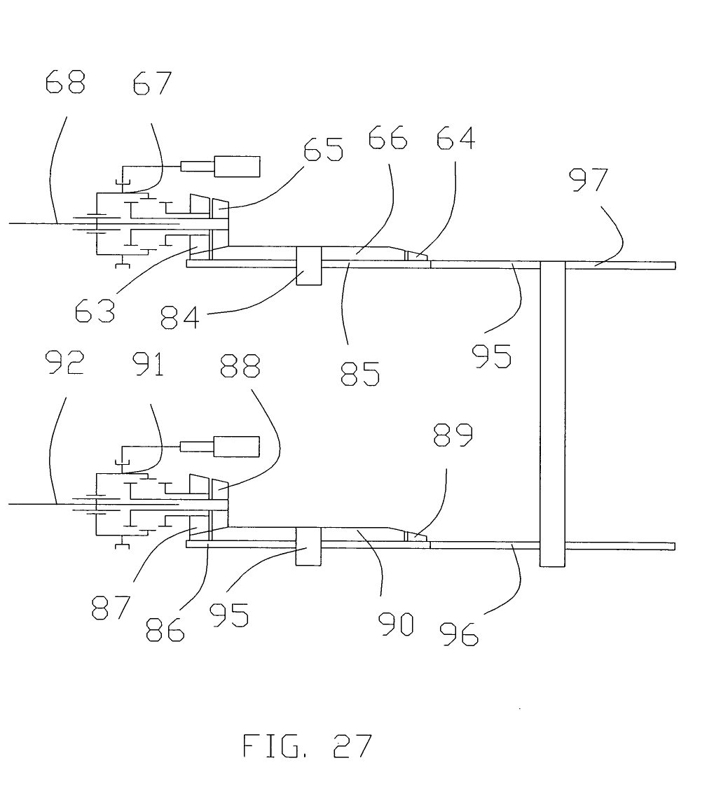

In FIG. 26 additional gears 87 and 88 are in mesh with gears 89 and 90. Size of gears 87 and 88 almost equals the size of gears 89 and 90. The ratio between gear 87 and 89 or 88 and 90 could be more or less than 1:1. Means 91 distinctly connects gears 87 and 88 to shaft 68. Shaft 92 is connected to gears 89 and 90. Shafts 92 and 74 are input/output shafts. This design could be used for eight speed gear box.

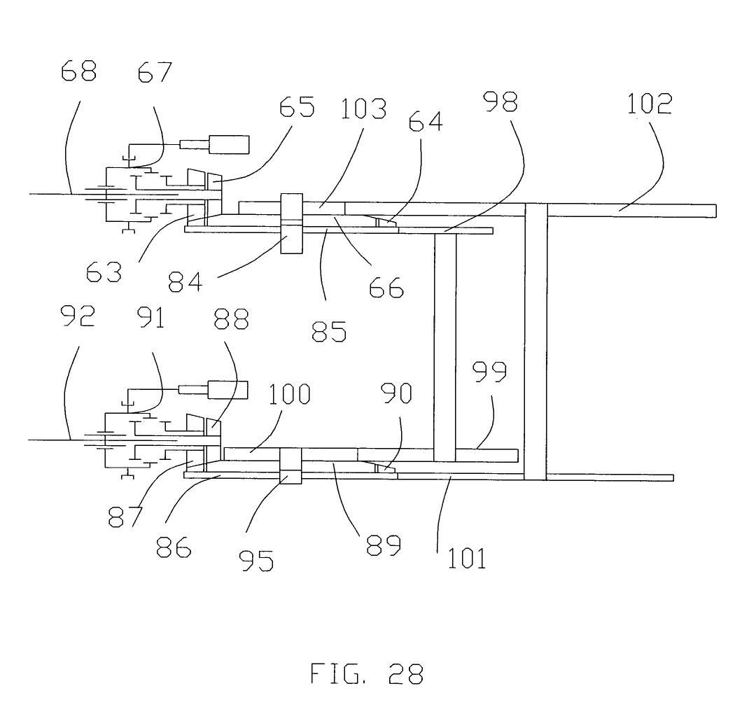

In FIG. 27 face gears 64 and 66 are attached to parallel shaft gear 85 and connected to shaft 84. Shaft 95 is connected to face gears 89 and 90 and parallel shaft gear 86. Gears 96 and 97 make kinematical connection between gears 85 and 86. Shafts 68 and 92 can be used for input/output of gear reduction unit. In FIG. 28 face gears 64 and parallel shaft gear 85 are kinematically connected by gears 98, 99 and 100 to face gear 89. Face gear 90 and parallel shaft gear 86 are kinematically connected by gears 101, 102 and 103 to face gear 66. This connection makes some ratio variations.

Gear reduction unit works like any gear reduction unit with constant gear mesh. By means according with the desired ratio it connects the chosen pinion to a shaft linking to a source of energy or load.

The reduced noise of the right angle gears, especially enveloping worm face transmission compared to any parallel shaft gears makes using the present invention more beneficial, particularly in helicopter or in motor vehicle power train applications.

For the same size of gears, this invention can provide up to twice the torque capacity of any parallel shaft transmissions.

Taped shape of the bevel type gears allows the use of very productive technology, like forging, or casting.

The basic inventive system of the present invention can be reconfigured into many different mechanical transmissions. For example, it can be used in a compact multi speed vehicle transaxle, integrated transmission and front axle car drive, integrated transmission and rear axle car drive, escalator drive, and more. The gear reduction unit described above can be utilized in a new layout of four-wheel vehicles.

### General Advantages of Gear Reduction Unit

The above described gear reduction unit transmits more power with smaller size. It is a compact alternative for spur or planetary transmissions in many applications, especially mobile.

The invention has high torque capacity due to the use of right angle gears with more power density. It applies even more when using enveloping worm face gears or enveloping worm gears with worm having threads with less than 90 degrees of revolution. In enveloping worm face gears contact pattern has motion along the tooth line: from left to right or from right to left depending on the direction of rotation. In hypoid or spiral bevel gears contact pattern has motion across the tooth: from the root to the tip or from the tip to the root depending on the direction of rotation. Enveloping gear has better lubrication condition (suction vs. squeezing out) that increase driving efficiency.

In automotive power train applications like front and rear drive axles, power take-off units, traction systems and mechanical amplifiers it saves up to 30% of space and significantly reduces weight. It will work in power windows and power seats, and steering drives.

Most of the time each thread (pinion tooth) of right angle gears is in mesh longer than any other pinion of parallel or planetary gears. It reduces impact of engagement and disengagement, increases the contact ratio and makes quieter motion.

Using existing gear cutting machines and forging or casting technology can make right angle gears cheaper to manufacture. There are very broad opportunities for the right angle gears made from plastic.

In the invention being thus described, it is obvious that the same may be varied in many ways. Such variations are not to be regarded as a departure from the spirit and scope of the invention, and all such modifications as would be obvious to one skilled in the art are intended to be included within the scope of the following claims.

1. Gear reduction unit comprising:
first right angle pair of gears;
second right angle pair of gears;
second gear of first pair of gears and second gear of second pair of gears are coaxially arranged;
an input shaft;
means for distinct connection of first gear of first pair of gears to the input shaft;

2. Gear reduction unit as recited in claim 1 wherein said means are distinctly connecting first gear of first pair of gears or first gear of second pair of gears to the input shaft.

3. Gear reduction unit as recited in claim 1 wherein the second gear of first pair of gears and second gear of second pair of gears are connected to each other.

4. Gear reduction unit as recited in claim 1 wherein the second gear of first pair of gears and second gear of second pair of gears are kinematically connected to each other.

5. Gear reduction unit as recited in claim 1 wherein said means are distinctly connecting first gears of first or second pair of gears to the input shaft and first gear of second pair of gears is connected to an output shaft.

6. Gear reduction unit as recited in claim 1 wherein said means are distinctly connecting first gear of first pair of gears or the output shaft to the input shaft.

7. Gear reduction unit as recited in claim 1 wherein it has an additional gear in mesh with second gear of first pair set of gears.

8. Gear reduction unit as recited in claim 1 wherein the first right angle pair of gears are bevel type gears and second right angle pair of gears are bevel type gears.

9. Gear reduction unit as recited in claim 1 wherein the first right angle pair of gears are worm gears and second right angle pair of gears are worm gears.

10. Gear reduction unit as recited in claim 1 wherein the first right angle pair of gears are face gears and second right angle pair of gears are face gears.

11. Gear reduction unit as recited in claim 1 wherein the first right angle pair of gears are bevel type gears and second right angle pair of gears are worm gears.

12. Gear reduction unit as recited in claim 1 wherein the first right angle pair of gears are bevel type gears and second right angle pair of gears are face gears.

13. Gear reduction unit as recited in claim 1 wherein the first right angle pair of gears are worm gears and second right angle pair of gears are face gears.

14. Gear reduction unit as recited in claim 1 wherein second gear of first pair of gears and second gear of second pair of gears have teeth faces facing in opposite directions.

15. Gear reduction unit comprising:
a first right angle pair of gears;
a second right angle pair of gears;
second gear of first pair of gears and second gear of second pair of gears are coaxially arranged;
an input shaft;
a third pair of right angle gears;
a fourth pair of right angle gears;
an output shaft;
means for a distinct connection of first gear of first pair of gears or first gear of second pair of gears to the input shaft;
an additional means for a distinct connection of first gear of third pair of gears or first gear of fourth pair of gears to the output shaft;
a second gear of first pair of gears in kinematical connection with second gear of third pair of gears and second gear of second pair of gears in kinematical connection with second gear of fourth pair of gears.

16. Gears for the reduction unit comprising:
a first gear from a right angle pair of gears;
a second gear from a right angle pair of gears;
a spur or helical type gear from a parallel shaft pair of gears;
said first gear, said second gear and said third gear spur are coaxially arranged and connected to each other.

17. Gears for the reduction unit as recited in claim 16 wherein said first gear and said second gear have teeth faces facing in opposite directions and said spur or helical type gear is locates between them.

18. Gears for the reduction unit as recited in claim 16 wherein said first gear is bevel type gear and said second gear is bevel type gear.

19. Gears for the reduction unit as recited in claim 16 wherein said first gear is face gear and said second gear is face gear.

20. Gears for the reduction unit as recited in claim 16 wherein said first gear is bevel type gear and said second gear is face gear.

21. Gears for the reduction unit as recited in claim 16 wherein it has a third gear from the right angle pair of gears coaxially arranged to said second gear.

22. Gears for the reduction unit as recited in claim 21 wherein said third gear is connected to said first and said second gears.

23. Gears for the reduction unit as recited in claim 16 wherein it has a fourth gear from a right angle pair of gears coaxially arranged and connected to said first, second and third gears and faces of said first and third gears have teeth faces facing in opposite directions to teeth faces of said second and fourth gears.
